(19) United States
(12) Patent Application Publication
(10) Pub. No.: US 2026/0330019 A1
(43) Pub. Date: Oct. 22, 2026

(54) PROGRAM

(71) Applicant: NEC Corporation, Tokyo (JP)

(72) Inventors: Narihito KIKUCHI, TOKYO (JP); Kei Kitamura, Tokyo (JP); Keisuke Ina, Tokyo (JP)

(73) Assignee: NEC Corporation, Tokyo (JP)

(21) Appl. No.: 19/558,924

(22) Filed: Mar. 6, 2026

(30) Foreign Application Priority Data
Mar. 18, 2025 (JP) 2025-043312

(51) Int. Cl. G06F 21/57

(52) U.S. Cl. CPC G06F 21/57

(57) ABSTRACT

An information processing apparatus of the present disclosure includes an acquisition unit that acquires physical configuration information indicating a physical configuration of a device and logical configuration information indicating a logical configuration of the device stored in advance in the device, and detects and acquires a current physical configuration and logical configuration of the device, and a verification unit that verifies whether the physical configuration and the physical configuration information match, and verifies whether the logical configuration and the logical configuration information match.

### INCORPORATION OF BASIC APPLICATION

The present invention is based upon and claims the benefit of the priority of Japanese Patent Application No. 2025-043312 filed on Mar. 18, 2025 in Japan, the disclosure of which is incorporated herein in its entirety by reference.

### TECHNICAL FIELD

The present disclosure relates to a program.

### BACKGROUND ART

In order to ensure the reliability of the information processing system, the hardware configuration is verified. For example, in PTL 1, the validity of the hardware configuration information is verified at the time of activation of the information processing apparatus.

PTL 1: JP 2022-166687 A

### SUMMARY

However, in the technique of PTL 1, since the hardware configuration is only verified, there arises a problem that the reliability of the information processing system cannot be further improved.

Therefore, an object of the present disclosure is to solve the above-described problem that the reliability of the information processing system cannot be further improved.

A program according to one aspect of the present disclosure causes an information processing apparatus to execute processing of acquiring physical configuration information indicating a physical configuration of a device and logical configuration information indicating a logical configuration of the device stored in advance in the device, and detecting and acquiring a current physical configuration and logical configuration of the device, and 10 information processing apparatus 11 acquisition unit 12 verification unit 13 output unit 14 acquisition information storage unit 100 information processing apparatus 101 CPU 102 ROM 103 RAM 104 programs 105 storage apparatus 106 drive apparatus 107 communication interface 108 input/output interface 109 bus 110 storage medium 111 communication network 121 acquisition unit 122 verification unit

verifying whether the physical configuration and the physical configuration information match, and verifying whether the logical configuration and the logical configuration information match.

An information processing method according to one aspect of the present disclosure includes,

by an information processing apparatus,

acquiring physical configuration information indicating a physical configuration of a device and logical configuration information indicating a logical configuration of the device stored in advance in the device, and detecting and acquiring a current physical configuration and logical configuration of the device, and

verifying whether the physical configuration and the physical configuration information match, and verifying whether the logical configuration and the logical configuration information match.

An information processing apparatus according to one aspect of the present disclosure includes

an acquisition unit that acquires physical configuration information indicating a physical configuration of a device and logical configuration information indicating a logical configuration of the device stored in advance in the device, and detects and acquires a current physical configuration and logical configuration of the device, and

a verification unit that verifies whether the physical configuration and the physical configuration information match, and verifies whether the logical configuration and the logical configuration information match.

With the above configurations, the present disclosure can further improve the reliability of the information processing system.

### BRIEF DESCRIPTION OF THE DRAWINGS

FIG. 1 is a block diagram illustrating an example of a configuration of an information processing apparatus according to the present disclosure;

FIG. 2 is a flowchart illustrating an example of a processing operation by the information processing apparatus according to the present disclosure;

FIG. 3 is a diagram illustrating an example of processing by the information processing apparatus according to the present disclosure;

FIG. 4 is a diagram illustrating an example of processing by the information processing apparatus according to the present disclosure;

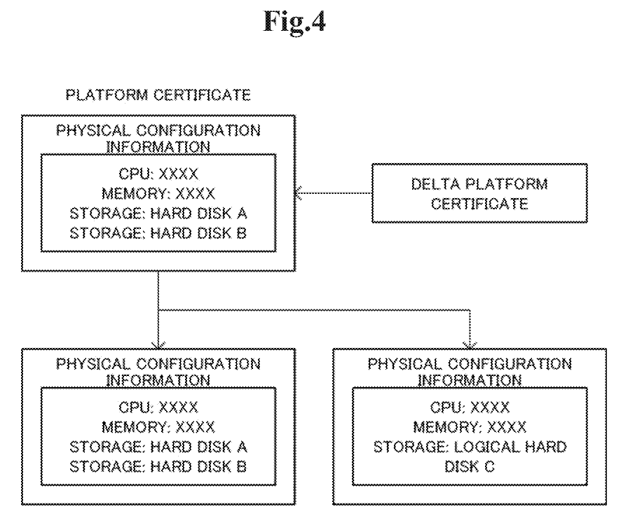

FIG. 5 is a block diagram illustrating an example of a hardware configuration of an information processing apparatus according to the present disclosure;

FIG. 6 is a block diagram illustrating an example of a configuration of an information processing apparatus according to the present disclosure; and

FIG. 7 is a flowchart illustrating an example of a processing operation by the information processing apparatus according to the present disclosure.

### EXAMPLE EMBODIMENT

### First Example Embodiment

A first example embodiment of the present disclosure will be described with reference to the drawings. The drawings may relate to any example embodiment.

As an example, an information processing apparatus 10 of the present disclosure is used to verify a configuration of an information processing system of a connected device or the like in order to ensure reliability of the information processing system. As an example, in the present example embodiment, a device 20 that is an information processing system to be verified is a storage apparatus that configures a predetermined type of redundant array of inexpensive disks (RAID), and the physical configuration and the logical configuration of the device 20 are verified.

However, in the present disclosure, the device 20 to be verified may be any information processing system. For example, the information processing system may include various peripheral devices such as a storage apparatus in addition to the plurality of information processing apparatuses.

Hereinafter, an example of a configuration and an operation of the information processing apparatus 10 according to the present example embodiment will be described. First, as described above, the device 20 as a verification target of the configuration is connected to the information processing apparatus 10. The device 20 includes hardware resources such as a central processing unit (CPU), a memory, and a storage.

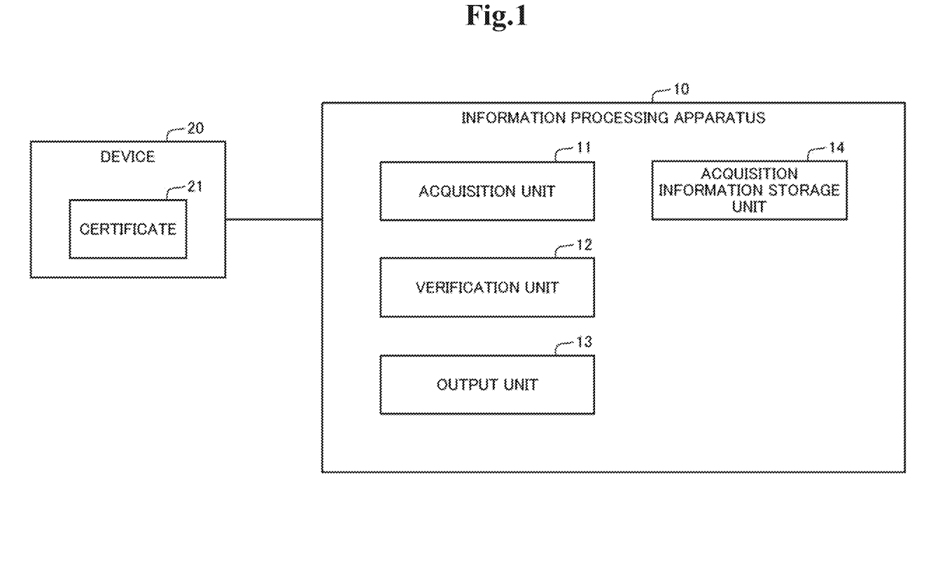

As illustrated in FIG. 1, it is assumed that a certificate 21 is stored in the device 20. In the present example embodiment, the certificate 21 is, for example, a platform certificate (Platform Certificate Profile) that is a standard by a group such as a Trusted Computing Group (TCG). The platform certificate is generated by a manufacturer at the time of shipment of the device 20 and is stored in the device 20, and is further signed to ensure validity of the configuration of the device 20.

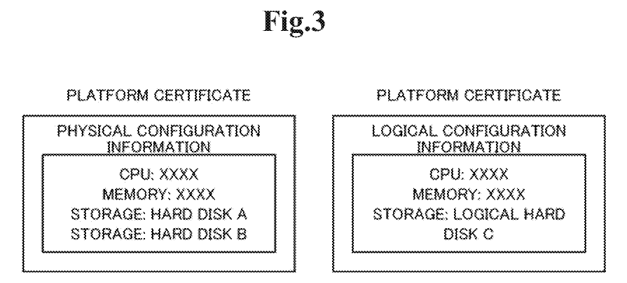

Specifically, the platform certificate includes physical configuration information indicating a physical configuration of the device 20 and logical configuration information indicating a logical configuration of the device 20. The physical configuration information includes identification information and specification information of a CPU, a memory, a storage, a network interface, and the like mounted on the device 20. As illustrated in FIG. 3, the physical configuration information of the platform certificate in the present example embodiment includes information such as a CPU “XXX”, a memory “XXX”, a storage “hard disk A”, and “hard disk B”. The logical configuration information includes logical configuration information such as types and versions of firmware and an operating system (OS) mounted on the device 20, hardware configuration information that can be confirmed from the OS, for example, setting of a logical volume and a redundant array of inexpensive disks (RAID) configuration, installed software, and the like. As illustrated in FIG. 3, the logical configuration information of the platform certificate in the present example embodiment includes information such as a CPU “XXX”, a memory “XXX”, and a storage “logical hard disk C”. That is, in the present example embodiment, the physical storage constituting the device 20 includes the “hard disk A” and the “hard disk B”, but the physical storage viewed from the OS includes the “logical hard disk C” because the RAID is constructed, and the physical configuration and the logical configuration are different.

The information processing apparatus 10 is configured with one or a plurality of information processing apparatuses including arithmetic apparatuses and storage apparatuses. Then, as illustrated in FIG. 1, the information processing apparatus 10 includes an acquisition unit 11, a verification unit 12, and an output unit 13. Each function of the acquisition unit 11, the verification unit 12, and the output unit 13 can be implemented by the arithmetic apparatus executing a program for implementing each function stored in the storage apparatus. The information processing apparatus 10 includes an acquisition information storage unit 14 implemented by a storage apparatus.

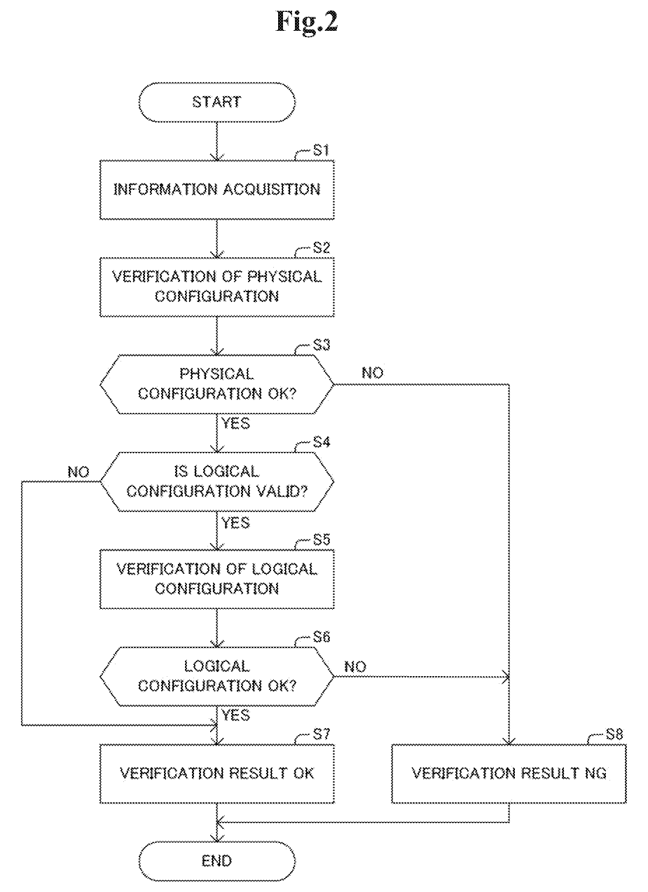

The acquisition unit 11 acquires the certificate 21 stored in the device 20 and stores the acquired certificate in the acquisition information storage unit 14 (step S1 in FIG. 2). In the present example embodiment, the acquisition unit 11 can acquire the platform certificate stored in the device 20 and recognize the physical configuration information and the logical configuration information indicating the information of the configuration at the time of shipment of the device 20 as illustrated in FIG. 3.

The acquisition unit 11 acquires information necessary for grasping the current physical configuration and logical configuration of the device 20 (step S2 in FIG. 2). For example, the acquisition unit 11 detects and acquires a physical configuration based on information such as the type, number, and configuration of hardware actually mounted on the device 20. For example, the acquisition unit 11 detects and acquires a hardware configuration that can be confirmed from the OS, for example, a logical configuration such as setting of a logical volume or a RAID configuration, installed software, or the like.

The verification unit 12 first compares the “physical configuration information” included in the acquired platform certificate with the actual “physical configuration” of the detected device 20, and verifies whether these are the same (step S3 in FIG. 2). Then, in a case where the physical configuration information matches the actual physical configuration, the verification unit 12 determines that the verification of the physical configuration has succeeded and determines that the physical configuration is OK (YES in step S3 in FIG. 2). On the other hand, in a case where the physical configuration information does not match the actual physical configuration (NO in step S3 in FIG. 2), it is determined that the verification of the physical configuration has failed and “verification result NG” is output (step S8 in FIG. 2), and the verification processing is terminated.

In a case where the physical configuration is OK (YES in step S3 in FIG. 2), the verification unit 12 checks the validity of the logical configuration detected from the device 20 (step S4 in FIG. 2). For example, the verification unit 12 determines whether there is a logical configuration different from the physical configuration according to the correspondence relationship between the physical configuration and the logical configuration. Then, in a case where the verification unit 12 determines that the logical configuration is not valid (NO in step S4 of FIG. 2), the verification of the logical configuration becomes unnecessary, and “verification result OK” is output (step S7 of FIG. 2).

On the other hand, in a case where the logical configuration is valid (YES in step S4 in FIG. 2), the verification unit 12 verifies the logical configuration. Specifically, the verification unit 12 compares the “logical configuration information” included in the acquired platform certificate with the actual “logical configuration” of the detected device 20, and verifies whether these are the same (step S5 in FIG. 2). Then, in a case where the logical configuration information matches the actual logical configuration, the verification unit 12 determines that the verification of the logical configuration is successful and determines that the logical configuration is OK (YES in step S6 of FIG. 2). On the other hand, in a case where the logical configuration information and the actual logical configuration do not match (NO in step S6 in FIG. 2), it is determined that the verification of the physical configuration has failed and “verification result NG” is output (step S8 in FIG. 2), and the verification processing is terminated.

In a case where the logical configuration is OK (YES in step S6 of FIG. 2), the verification unit 12 outputs “verification result OK” (step S7 of FIG. 2). That is, the verification unit 12 determines that the verification is successful in a case where both the physical configuration and the logical configuration match the information included in the platform certificate. Then, the verification unit 12 notifies the user who needs the verification result by displaying the fact that the verification is successful on the display apparatus of the information processing apparatus 10 or transmitting the fact to another information processing terminal. On the other hand, in a case where the verification result is NG, the verification unit 12 displays the fact that the verification has failed on the display apparatus of the information processing apparatus 10 or transmits the fact to another information processing terminal, thereby notifying the user who needs the verification result, and urging the user to take action.

As described above, in the present disclosure, by comparing and verifying the physical configuration information and the logical configuration information included in the certificate at the time of shipment of the device 20 with the current physical configuration and logical configuration of the device 20, it is possible to confirm that there is no unauthorized change from the time of shipment in both the physical configuration and the logical configuration. As a result, the reliability of the device 20 can be further improved.

### Second Example Embodiment

Next, a second example embodiment of the present disclosure will be described with reference to the drawings. The drawings may relate to any example embodiment.

The information processing apparatus 10 according to the present example embodiment has a configuration similar to that of the first example embodiment described above. In addition, the information processing apparatus 10 has the following configuration. Hereinafter, a configuration different from the above will be mainly described.

The device 20 connected to the information processing apparatus 10 according to the present example embodiment stores, as the certificate 21, a delta platform certificate indicating a difference before and after the configuration of the device 20 is changed, in addition to the platform certificate described above.

The delta platform certificate is a certificate in which a change content of the device 20 performed later is recorded with respect to the basic platform certificate described above, and is issued and registered in a case where a device procurer, an original equipment manufacturing (OEM) destination, a person in charge of maintenance, or the like changes a hardware configuration of the device or installs and customizes firmware or an OS, or changes a logical configuration such as a case where a setting of a logical volume or a RAID configuration is changed or installed software is changed. As a result, the delta platform certificate includes physical configuration change information indicating a difference before and after the change in the physical configuration of the device and logical configuration change information indicating a difference before and after the change in the logical configuration of the device.

The acquisition unit 11 in the present example embodiment acquires a delta platform certificate which is the certificate 21 stored in the device 20, and acquires the physical configuration change information and the logical configuration change information described above. Then, the acquisition unit 11 calculates physical configuration information and logical configuration information indicating the configuration information of the device 20 using the platform certificate and the delta platform certificate. Here, as an example, it is assumed that the physical configuration is changed from the physical configuration A serving as the initial master based on the platform certificate, and the physical configuration difference information B representing the change in the physical configuration from the physical configuration A based on the delta platform certificate and the logical configuration change difference C representing the change in the logical configuration from the physical configuration A are acquired. In this case, it is conceivable that the physical configuration information is calculated by A+C and the logical configuration information is calculated by A+B+C. As another case, there is a case where the physical configuration information is calculated as A+B and the logical configuration information is calculated as A+C by using the difference B in the physical configuration from A and the logical configuration change difference C including the physical configuration difference from A.

Then, the verification unit 12 according to the present example embodiment compares the “physical configuration information” calculated based on the platform certificate and the delta platform certificate as described above with the actual “physical configuration” of the detected device 20, and verifies whether these are the same. The verification unit 12 compares the “logical configuration information” calculated based on the platform certificate and the delta platform certificate with the actual “logical configuration” of the detected device 20, and verifies whether these are the same. As a result, similarly to the above, the verification unit 12 can determine that the verification is successful in a case where both the actual physical configuration and the logical configuration match the physical configuration information and the logical configuration information based on the information included in the platform certificate and the delta platform certificate.

As described above, in the present disclosure, by applying the difference information of the delta platform certificate to the platform certificate, it is possible to calculate the current physical configuration information and the logical configuration information and to collate the current physical configuration information and the logical configuration information with the actual configuration of the device 20. As a result, it is possible to verify whether the configuration of the device 20 reflecting the latest change content is unauthorized.

### Third Example Embodiment

Next, a third example embodiment of the present disclosure will be described with reference to the drawings. In the present example embodiment, an outline of the information processing apparatuses and the like described in the above-described example embodiments will be illustrated. The drawings may relate to any example embodiment.

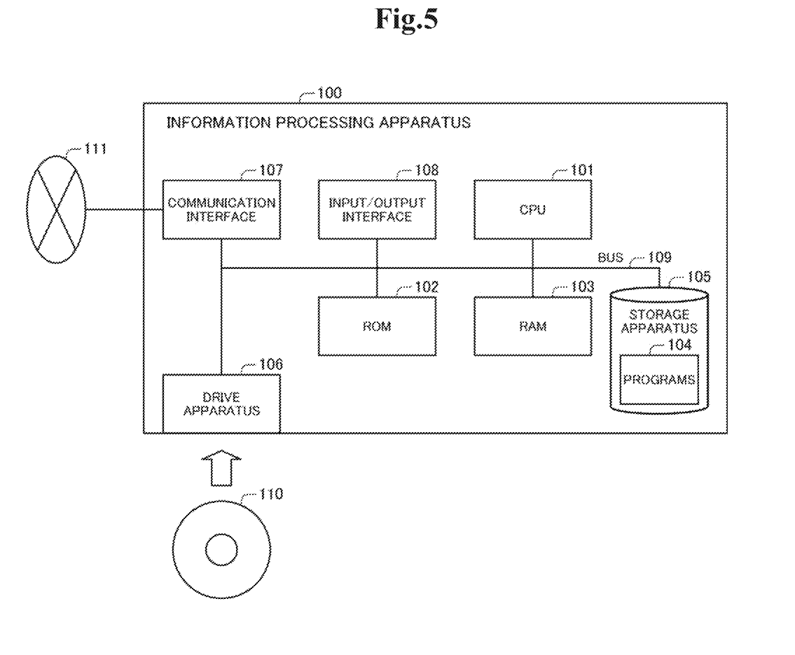

First, a hardware configuration of an information processing apparatus 100 in the present disclosure will be described. The information processing apparatus 100 is configured as a general information processing apparatus, and as an example, as illustrated in FIG. 5, is equipped with the following hardware configuration.
A central processing unit (CPU) 101 (arithmetic apparatus)
A read only memory (ROM) 102 (storage apparatus)
A random access memory (RAM) 103 (storage apparatus)
Programs 104 to be loaded into the RAM 103
A storage apparatus 105 that stores the programs 104
A drive apparatus 106 that performs reading and writing on a storage medium 110 outside the information processing apparatus
A communication interface 107 connected to a communication network 111 outside the information processing apparatus
An input/output interface 108 that inputs and outputs data
A bus 109 that connects each component

FIG. 5 illustrates an example of a hardware configuration of the information processing apparatus that is the information processing apparatus 100, and the hardware configuration of the information processing apparatus is not limited to the above-described case. For example, the information processing apparatus may be constituted by a part of the above-described configuration such as not including the drive apparatus 106. The information processing apparatus can use, instead of the above-described CPU, a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

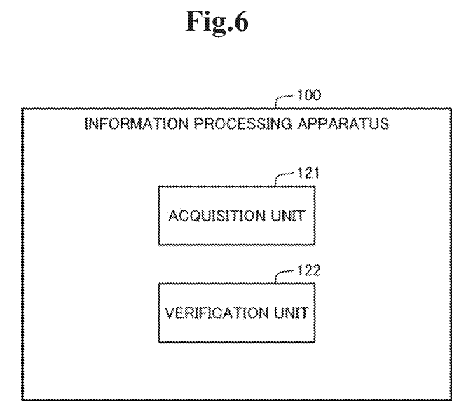

Then, the information processing apparatus 100 can construct and equip the acquisition unit 121 and the verification unit 122 illustrated in FIG. 6 by the CPU 101 acquiring the programs 104 and the CPU 101 executing the programs. The programs 104 are stored in, for example, the storage apparatus 105 or the ROM 102 in advance, and the CPU 101 loads and executes the programs 104 on the RAM 103, as necessary. The programs 104 may be supplied to the CPU 101 via the communication network 111, or the programs 104 may be stored in the storage medium 110 in advance and the drive apparatus 106 may read the programs 104 and supply the read programs 104 to the CPU 101. However, the acquisition unit 121 and the verification unit 122 described above may be constructed with a dedicated electronic circuit for implementing such means.

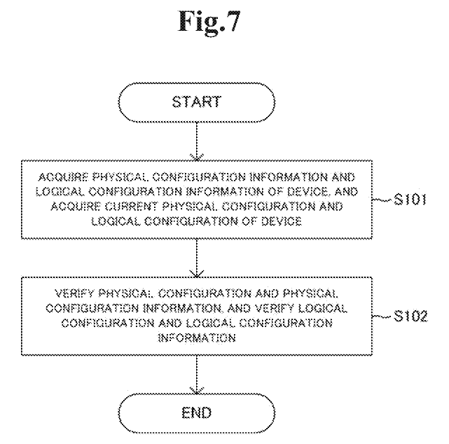

The acquisition unit 121 acquires the physical configuration information indicating the physical configuration of the device and the logical configuration information indicating the logical configuration of the device stored in advance in the device, and detects and acquires the current physical configuration and logical configuration of the device (step S101 in FIG. 7). The verification unit 122 verifies whether the physical configuration and the physical configuration information match, and also verifies whether the logical configuration and the logical configuration information match (step S102 in FIG. 7).

In the above configuration, for example, the information processing apparatus 100 acquires the physical configuration information and the logical configuration information of the device from the platform certificate according to a predetermined standard, and verifies whether the current physical configuration and logical configuration of the device match. For example, the information processing apparatus 100 may acquire the physical configuration change information and the logical configuration change information of the device from the delta platform certificate according to a predetermined standard, calculate the physical configuration information and the logical configuration information of the device, and verify whether the current physical configuration and logical configuration of the device match. As a result, it is possible to confirm that there is no unauthorized change in the device, and it is possible to further improve the reliability of the device.

At least one or more of the functions of the acquisition unit 121 and the verification unit 122 described above may be executed by an information processing apparatus installed and connected to any place on the network, that is, may be executed by so-called cloud computing.

The above-described programs can be stored using various types of non-transitory computer readable media and supplied to a computer. The non-transitory computer readable media include various types of tangible storage media. Examples of the non-transitory computer readable medium include a magnetic recording medium (for example, a flexible disk, a magnetic tape, or a hard disk drive), a magneto-optical recording medium (for example, a magneto-optical disk), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM)). The programs may also be supplied to the computer by various types of transitory computer readable media. Examples of the transitory computer readable media include electrical signals, optical signals, and electromagnetic waves. The transitory computer readable media can supply the programs to the computer via a wired communication path such as an electric wire and an optical fiber, or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

### Supplementary Note

Some or all of the above example embodiments may also be described as in the following Supplementary Notes. Hereinafter, an outline of configurations of the information processing apparatus, the information processing method, and the program in the present disclosure will be described. However, the present disclosure is not limited to the configurations described in the following Supplementary Notes.

Some or all of the configurations described in Supplementary Notes 2 to 5 dependent on Supplementary Note 1 described below and the functions according to those configurations can also be dependent on other Supplementary Notes 6 and 9 by a dependency relationship similar to that of Supplementary Notes 2 to 5. Moreover, one, some, or all of the configurations described as Supplementary Notes and the functions according to those configurations can be similarly dependent from not only Supplementary Notes 1, 6, and 9, but also various pieces of similar hardware and software, and various types of recording means for recording the software, or systems without departing from the above-described example embodiments.

### Supplementary Note 1

A program for causing
an information processing apparatus to execute processing of:
   acquiring physical configuration information indicating a physical configuration of a device and logical configuration information indicating a logical configuration of the device stored in advance in the device, and detecting and acquiring a current physical configuration and logical configuration of the device; and
   verifying whether the physical configuration and the physical configuration information match, and verifying whether the logical configuration and the logical configuration information match.

### Supplementary Note 2

The program according to Supplementary Note 1, causing
the information processing apparatus to execute processing of:
   acquiring physical configuration change information representing information based on a change in the physical configuration of the device and logical configuration change information representing information based on a change in the logical configuration of the device, the physical configuration change information and the logical configuration change information being stored in advance in the device, and calculating the physical configuration information and the logical configuration information using the physical configuration change information and the logical configuration change information; and
   verifying whether the physical configuration information calculated matches the physical configuration, and verifying whether the logical configuration information calculated matches the logical configuration.

### Supplementary Note 3

The program according to Supplementary Note 2, causing
the information processing apparatus to execute processing of
acquiring the physical configuration change information indicating a difference before and after a change in the physical configuration of the device and the logical configuration change information indicating a difference before and after a change in the logical configuration of the device, the physical configuration change information and the logical configuration change information being stored in advance in the device.

### Supplementary Note 4

The program according to Supplementary Note 1, causing
the information processing apparatus to execute processing of
acquiring a platform certificate according to a predetermined standard including the physical configuration information and the logical configuration information, the platform certificate being stored in advance in the device.

### Supplementary Note 5

The program according to Supplementary Note 2, causing
the information processing apparatus to execute processing of
acquiring a delta platform certificate according to a predetermined standard, the delta platform certificate including the physical configuration change information and the logical configuration change information, the delta platform certificate being stored in advance in the device.

### Supplementary Note 6

An information processing method including,
by an information processing apparatus:
   acquiring physical configuration information indicating a physical configuration of a device and logical configuration information indicating a logical configuration of the device stored in advance in the device, and detecting and acquiring a current physical configuration and logical configuration of the device; and
   verifying whether the physical configuration and the physical configuration information match, and verifying whether the logical configuration and the logical configuration information match.

### Supplementary Note 7

The information processing method according to Supplementary Note 6, further including,
by the information processing apparatus:
   acquiring physical configuration change information representing information based on a change in the physical configuration of the device and logical configuration change information representing information based on a change in the logical configuration of the device, the physical configuration change information and the logical configuration change information being stored in advance in the device, and calculating the physical configuration information and the logical configuration information using the physical configuration change information and the logical configuration change information; and
   verifying whether the physical configuration information calculated matches the physical configuration, and verifying whether the logical configuration information calculated matches the logical configuration.

### Supplementary Note 8

The information processing method according to Supplementary Note 7, further including,
by the information processing apparatus,
acquiring the physical configuration change information indicating a difference before and after a change in the physical configuration of the device and the logical configuration change information indicating a difference before and after a change in the logical configuration of the device, the physical configuration change information and the logical configuration change information being stored in advance in the device.

### Supplementary Note 9

An information processing apparatus including:
an acquisition unit that acquires physical configuration information indicating a physical configuration of a device and logical configuration information indicating a logical configuration of the device stored in advance in the device, and detects and acquires a current physical configuration and logical configuration of the device; and
a verification unit that verifies whether the physical configuration and the physical configuration information match, and verifies whether the logical configuration and the logical configuration information match.

### Supplementary Note 10

The information processing apparatus according to Supplementary Note 9, wherein
the acquisition unit acquires physical configuration change information representing information based on a change in the physical configuration of the device and logical configuration change information representing information based on a change in the logical configuration of the device, the physical configuration change information and the logical configuration change information being stored in advance in the device, and calculates the physical configuration information and the logical configuration information using the physical configuration change information and the logical configuration change information; and
the verification unit verifies whether the physical configuration information calculated matches the physical configuration, and verifies whether the logical configuration information calculated matches the logical configuration.

### Reference Signs List

10 information processing apparatus

11 acquisition unit

12 verification unit

13 output unit

14 acquisition information storage unit

100 information processing apparatus

101 CPU

102 ROM

103 RAM

104 programs

105 storage apparatus

106 drive apparatus

107 communication interface

108 input/output interface

109 bus

110 storage medium

111 communication network

121 acquisition unit

122 verification unit

1. A non-transitory computer-readable storage medium storing a program for causing
an information processing apparatus to execute processing of:
acquiring physical configuration information indicating a physical configuration of a device and logical configuration information indicating a logical configuration of the device stored in advance in the device, and detecting and acquiring a current physical configuration and logical configuration of the device; and
verifying whether the physical configuration and the physical configuration information match, and verifying whether the logical configuration and the logical configuration information match.

2. The non-transitory computer-readable storage medium storing the program according to claim 1,
the program further causing
the information processing apparatus to execute processing of:
acquiring physical configuration change information representing information based on a change in the physical configuration of the device and logical configuration change information representing information based on a change in the logical configuration of the device, the physical configuration change information and the logical configuration change information being stored in advance in the device, and calculating the physical configuration information and the logical configuration information using the physical configuration change information and the logical configuration change information; and
verifying whether the physical configuration information calculated matches the physical configuration, and verifying whether the logical configuration information calculated matches the logical configuration.

3. The non-transitory computer-readable storage medium storing the program according to claim 2,
the program further causing
the information processing apparatus to execute processing of
acquiring the physical configuration change information indicating a difference before and after a change in the physical configuration of the device and the logical configuration change information indicating a difference before and after a change in the logical configuration of the device, the physical configuration change information and the logical configuration change information being stored in advance in the device.

4. The non-transitory computer-readable storage medium storing the program according to claim 1,
the program further causing
the information processing apparatus to execute processing of
acquiring a platform certificate according to a predetermined standard including the physical configuration information and the logical configuration information, the platform certificate being stored in advance in the device.

5. The non-transitory computer-readable storage medium storing the program according to claim 2,
the program further causing
the information processing apparatus to execute processing of
acquiring a delta platform certificate according to a predetermined standard, the delta platform certificate including the physical configuration change information and the logical configuration change information, the delta platform certificate being stored in advance in the device.

6. An information processing method comprising,
by an information processing apparatus:
acquiring physical configuration information indicating a physical configuration of a device and logical configuration information indicating a logical configuration of the device stored in advance in the device, and detecting and acquiring a current physical configuration and logical configuration of the device; and
verifying whether the physical configuration and the physical configuration information match, and verifying whether the logical configuration and the logical configuration information match.

7. The information processing method according to claim 6, further comprising,
by the information processing apparatus:
acquiring physical configuration change information representing information based on a change in the physical configuration of the device and logical configuration change information representing information based on a change in the logical configuration of the device, the physical configuration change information and the logical configuration change information being stored in advance in the device, and calculating the physical configuration information and the logical configuration information using the physical configuration change information and the logical configuration change information; and
verifying whether the physical configuration information calculated matches the physical configuration, and verifying whether the logical configuration information calculated matches the logical configuration.

8. The information processing method according to claim 7, further comprising,
by the information processing apparatus,
acquiring the physical configuration change information indicating a difference before and after a change in the physical configuration of the device and the logical configuration change information indicating a difference before and after a change in the logical configuration of the device, the physical configuration change information and the logical configuration change information being stored in advance in the device.

9. The information processing method according to claim 6, further comprising,
by the information processing apparatus,
acquiring a platform certificate according to a predetermined standard including the physical configuration information and the logical configuration information, the platform certificate being stored in advance in the device.

10. The information processing method according to claim 7, further comprising,
by the information processing apparatus,
acquiring a delta platform certificate according to a predetermined standard, the delta platform certificate including the physical configuration change information and the logical configuration change information, the delta platform certificate being stored in advance in the device.

11. An information processing apparatus comprising:
at least one memory configured to store processing instructions; and
at least one processor configured to execute the processing instructions to:
acquire physical configuration information indicating a physical configuration of a device and logical configuration information indicating a logical configuration of the device stored in advance in the device, and detect and acquire a current physical configuration and logical configuration of the device; and
verify whether the physical configuration and the physical configuration information match, and verify whether the logical configuration and the logical configuration information match.

12. The information processing apparatus according to claim 9, wherein the at least one processor is configured to execute the processing instructions to:
acquire physical configuration change information representing information based on a change in the physical configuration of the device and logical configuration change information representing information based on a change in the logical configuration of the device, the physical configuration change information and the logical configuration change information being stored in advance in the device, and calculate the physical configuration information and the logical configuration information using the physical configuration change information and the logical configuration change information; and
verify whether the physical configuration information calculated matches the physical configuration, and verify whether the logical configuration information calculated matches the logical configuration.

13. The information processing apparatus according to claim 12, wherein the at least one processor is configured to execute the processing instructions to
acquire the physical configuration change information indicating a difference before and after a change in the physical configuration of the device and the logical configuration change information indicating a difference before and after a change in the logical configuration of the device, the physical configuration change information and the logical configuration change information being stored in advance in the device.

14. The information processing apparatus according to claim 11, wherein the at least one processor is configured to execute the processing instructions to
acquire a platform certificate according to a predetermined standard including the physical configuration information and the logical configuration information, the platform certificate being stored in advance in the device.

15. The information processing apparatus according to claim 12, wherein the at least one processor is configured to execute the processing instructions to
acquire a delta platform certificate according to a predetermined standard, the delta platform certificate including the physical configuration change information and the logical configuration change information, the delta platform certificate being stored in advance in the device.
